(19) United States
(12) Patent Application Publication
(10) Pub. No.: US 2017/0153384 A1
(43) Pub. Date: Jun. 1, 2017

(54) BACKLIGHT MODULE AND DISPLAY DEVICE

(71) Applicants: Shenzhen China Star Optoelectronics Technology Co. Ltd., Shenzhen, Guangdong (CN); Wuhan China Star Optoelectronics Technology Co., Ltd., Wuhan, Hubei (CN)

(72) Inventor: Jie ZENG, Shenzhen, Guangdong (CN)

(73) Assignees: Shenzhen China Star Optoelectronics Technology Co. Ltd., Shenzhen, Guangdong (CN); WUHAN CHINA STAR OPTEOELECTRONICS TECHNOLOGY CO., LTD., Wuhan, Hubei (CN)

(21) Appl. No.: 14/778,589

(22) PCT Filed: Jun. 30, 2015
(86) PCT No.: PCT/CN2015/082797

§ 371 Date: Sep. 19, 2015

(30) Foreign Application Priority Data
Jun. 12, 2015 (CN) 201510326065.X

(51) Int. Cl. F21V 8/00

(52) U.S. Cl. CPC G02B 6/0088; G02B 6/0055; G02B 6/005

(57) ABSTRACT

The present invention provides a backlight module, and the backlight module comprises a glue frame, a light guide plate, a backlight source, a reflective sheet and a quantum dot thin film, and the light guide plate, the backlight source, the reflective sheet, the quantum dot thin film are located in the glue frame, and the backlight source is located at an incident side of the light guide plate, and the quantum dot thin film comprises a mainbody and extending sections at opposite two ends of the mainbody, and the reflective sheet and a mainbody layer of the quantum dot thin film stack at two opposite surfaces of the light guide plate, and the two opposite extending sections are respectively bent toward the incident side of the light guide plate and the other side opposite to the incident side and adhered on the reflective sheet. The present invention further discloses a display device.

### CROSS REFERENCE

This application claims the priority of Chinese Patent Application No. 201510326065.X, entitled “Backlight module and display device”, filed on Jun. 12, 2015, the disclosure of which is incorporated herein by reference in its entirety.

### FIELD OF THE INVENTION

The present invention relates to a liquid crystal display field, and more particularly to a backlight module and a display device.

### BACKGROUND OF THE INVENTION

The liquid crystal display device is the main stream flat panel display device technology in the present market. All display devices need backlight to be the light source for illuminating the liquid crystal display device. The traditional backlight module comprises a backlight source consisted of LEDs, and as the light of the backlight module passes through the light guide plate, the light source is converted into a surface light source to for illumination, and after the lighting uniformity of the diffuser, the light exits from the backlight module. After the liquid crystal panel, the image we want can be shown. With the progress of the technology, the requirements of the people to the display device quality has become higher and higher. The high color gamut is a hot topic in the related field.

In the present market, a popular technology is to utilize the quantum dot to improve the backlight color gamut. The quantum dot is quasi-zero-dimensional nano material, and constructed by a small amount of atoms; the diameters are generally between 1-10 nm. Because the electrons and holes are in quantum confinement, and the continuous energy band structure becomes the discrete energy level structure with molecule property, which can irradiate fluorescent light after being excited and then can change the color gamut of the coming light.

In the backlight module, the quantum dot thin film is mainly employed to replace the phosphor, and the quantum dot thin film is loaded between the light guide plate and the prismatic glass to improve the color gamut of the liquid crystal display device. However, the quantum dot thin film is easy to be influenced by the external conditions, such as water and oxygen. The package is very thick (generally, the quantum dot film can be thicker more than 210 μm), and the issue of edge failure exists. Therefore, the application for the electronic products, and particularly the thin type mobile phone is restricted.

### SUMMARY OF THE INVENTION

An objective of the present invention is to provide a backlight module to solve the technical problem of the edge failure when the quantum dot thin film raises the backlight color gamut.

The present invention further provides a display device.

For realizing the aforesaid objective, the technical solution provided by the embodiments of the present invention is:

The present invention provides a backlight module, and the backlight module comprises a glue frame, a light guide plate, a backlight source, a reflective sheet and a quantum dot thin film, and the light guide plate, the backlight source, the reflective sheet, the quantum dot thin film are located in the glue frame, and the backlight source is located at an incident side of the light guide plate, and the quantum dot thin film comprises a mainbody and extending sections at opposite two ends of the mainbody, and the reflective sheet and a mainbody layer of the quantum dot thin film stack at two opposite surfaces of the light guide plate, and the two opposite extending sections are respectively bent toward the incident side of the light guide plate and the other side opposite to the incident side and adhered on the reflective sheet.

The light guide plate comprises a lateral surface opposite to the incident side, and an illuminating surface connecting the incident side and the lateral surface and a bottom surface opposite to the illuminating surface, and the reflective sheet stacks on the bottom surface, and the quantum dot thin film stacks on the illuminating surface, and the two extending sections are respectively bent toward the incident side and the lateral surface and adhered on a surface of the reflective sheet away from the bottom surface.

Double-side tapes are provided between the two extending sections and the reflective sheet.

Double-side tapes are provided at the two extending sections away from surfaces of the reflective sheet, and the periphery of the double-side tapes are fixed with the side frame.

A length of the extending section of the quantum dot thin film bent and adhered with the reflective sheet is smaller than a half of a length of the reflective sheet.

The backlight module further comprises an optical film, and the optical film stacks on the mainbody of the quantum dot thin film.

An edge of the extending section of the quantum dot thin film in an extending direction is a cut edge as cutting the quantum dot thin film.

The quantum dot thin film is formed with quantum dots of mixed various sizes which are packaged by PET material.

The present invention provides a display device, comprising a liquid crystal panel and the aforesaid backlight module. The liquid crystal panel is located on the backlight module, and the liquid crystal panel covers the optical film.

As double-side tapes are provided on surface of the two extending sections away from the reflective sheet, the double-side tapes are employed to fix the liquid crystal panel and the optical film.

In the backlight module of the present invention, the edges of the quantum dot thin film which can be easily fail in the cutting process are located at the bottom of the reflective sheet. It does not influence the light entrance and exit of the light guide plate, and meanwhile, prevent the display image result being influenced by the quantum dot failure at the edge parts of the illuminating surface of the light guide plate.

### BRIEF DESCRIPTION OF THE DRAWINGS

In order to more clearly illustrate the embodiments of the present invention, the following figures will be described in the embodiments are briefly introduced. It is obvious that the drawings are only some embodiments of the present invention, those of ordinary skill in this field can obtain other figures according to these figures without paying the premise.

FIG. 1 is a sectional diagram of backlight module according to the preferred embodiment of the present invention.

FIG. 2 is a sectional diagram of another arrangement of a quantum dot thin film in the backlight module of the present invention.

### DETAILED DESCRIPTION OF PREFERRED EMBODIMENTS

For better explaining the technical solution and the effect of the present invention, the present invention will be further described in detail with the accompanying drawings in the specific embodiments.

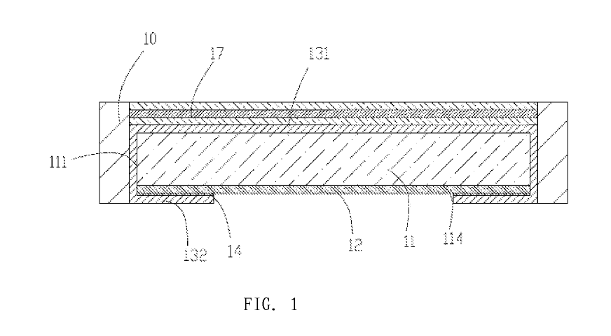

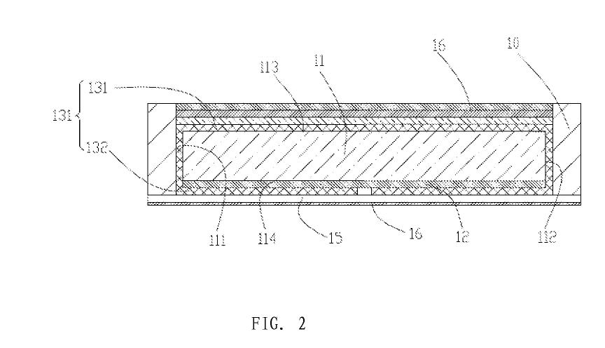

Please refer to FIG. 1 and FIG. 2. The preferred embodiment of the present invention provides a backlight module. The backlight module comprises a glue frame 10, a light guide plate 11, a backlight source (not shown), a reflective sheet 12 and a quantum dot thin film 13. The light guide plate 11, the backlight source, the reflective sheet 12, the quantum dot thin film 13 are located in the glue frame 10. The backlight source is at an incident side 111 of the light guide plate 12. The quantum dot thin film 13 comprises a mainbody 131 and extending sections 132 at opposite two ends of the mainbody 131, and the reflective sheet 12 and a mainbody layer 131 of the quantum dot thin film 13 stack at two opposite surfaces of the light guide plate 11, and the two opposite extending sections 132 are respectively bent toward the incident side 111 of the light guide plate 11 and the other side opposite to the incident side 111 and adhered on the reflective sheet 12.

Specifically, the glue frame 10 is a rectangular frame, and the quantum dot thin film 13, the light guide plate 11 and the reflective sheet 12 stack in order. The glue frame 10 surrounds a periphery of the assembly comprising the quantum dot thin film 13, the light guide plate 11 and the reflective sheet 12. The backlight source is a LED lamp, which is located between the glue frame 10 and the incident side of the light guide plate 11 to provide light for the backlight module.

Furthermore, the light guide plate 11 comprises a lateral surface 112 opposite to the incident side 111, and an illuminating surface 113 connecting the incident side 111 and the lateral surface 112 and a bottom surface 114 opposite to the illuminating surface 113. The reflective sheet 12 stacks on the bottom surface 114, and the quantum dot thin film 13 stacks on the illuminating surface 113. The two extending sections 132 are respectively bent toward the incident side 111 and the lateral surface 112 and adhered on a surface of the reflective sheet 12 away from the bottom surface 114. Here, it can be understood that the extending sections 132 are bent toward the incident side 111 and the lateral surface 112 and closely adhered on the incident side 111 and the lateral surface 112, and then, are bent to a plane where the reflective sheet 12 is to be adhered to the reflective sheet 12.

Furthermore, a length of the extending section 132 of the quantum dot thin film 13 bent and adhered with the reflective sheet 12 is smaller than a half of a length of the reflective sheet 12. In this embodiment, the adhered length of the extending section 132 and the reflective sheet 12 can be determined according to specific condition. The best solution is to prevent the influence of the edge failure of the extending section 132 to the backlight and perfectly to fix the quantum dot thin film 13 for achieving the cost balance.

Specifically, the light guide plate 11 is a rectangular plate. The quantum dot thin film 13 is a rectangular plate, and a width is equal to a width of the light guide plate 11, i.e. a length of the incident side. Preferably, the width of the quantum dot thin film 13 is equal to width of the light guide plate 11. A length of the quantum dot thin film 13 is larger than a length of the light guide plate 11, i.e. a distance between the light guide plate 11 and the lateral surface 112. A length of the extending section 132 of the quantum dot thin film 13 adhered with the reflective sheet 12 is larger than 1 mm.

The quantum dot thin film 13 is manufactured by cutting a thin film substrate formed with quantum dots of mixed various sizes which are packaged by PET material. In other words, the quantum dots have various sizes or partially the same sizes and mixed according a ratio. An edge of the extending section 132 of the quantum dot thin film 13 in an extending direction is a cut edge as cutting the quantum dot thin film. The edges can be easily influenced by the external conditions, such as water and oxygen, and the issue of edge failure exists. However, the present invention locates the quantum dot thin film 13 under the reflective sheet 12 but not parallel with the edge of the illuminating surface 113 of the light guide plate 11. It prevents that the quantum dot thin film failure of the edges of the illuminating surface 113 to influence the light illumination quality. Moreover, the edges of the of the illuminating surface 113, which can easily fail are located under the reflective sheet 12 and do not influence the light exit of the light guide plate.

Furthermore, as shown in FIG. 1, double-side tapes 14 are provided between the two extending sections 132 and the reflective sheet 12. The double-side tapes 14 fix the two extending sections 132 and the reflective sheet 12 and save the usage amount of the double-side tapes.

Furthermore, as shown in FIG. 2, the double-side tapes 15 are provided at the two extending sections 132 away from surfaces of the reflective sheet 12, and the periphery of the double-side tapes 15 are fixed with the side frame 10. Meanwhile, a protective film 16 is provided on an outer surface of the double-side tape 15 to protect the double-side tape 15 from failure due to pollution.

Furthermore, the backlight module further comprises an optical film 17, and the optical film 17 covers on the mainbody 131 of the quantum dot thin film 13.

The present invention provides a display device, comprising a liquid crystal panel and the aforesaid backlight module. The liquid crystal panel is located on the backlight module, and the liquid crystal panel covers the optical film 17.

The backlight module of the present invention utilizes the quantum dot thin film 13 to realize the high color gamut display quality of the display device, and the edges of the quantum dot thin film 13, which easily fail in the cutting process are located at the bottom of the reflective sheet. It does not influence the light entrance and exit of the light guide plate, and meanwhile, prevent the display image result being influenced by the quantum dot failure at the edge parts of the illuminating surface 113 of the light guide plate 11. The structure of the backlight module according to the present invention is simple, and guarantees the high color gamut of the display module.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A backlight module, wherein the backlight module comprises a glue frame, a light guide plate, a backlight source, a reflective sheet and a quantum dot thin film, and the light guide plate, the backlight source, the reflective sheet, the quantum dot thin film are located in the glue frame, and the backlight source is located at an incident side of the light guide plate, and the quantum dot thin film comprises a mainbody and extending sections at opposite two ends of the mainbody, and the reflective sheet and a mainbody layer of the quantum dot thin film stack at two opposite surfaces of the light guide plate, and the two opposite extending sections are respectively bent toward the incident side of the light guide plate and the other side opposite to the incident side and adhered on the reflective sheet.

2. The backlight module according to claim 1, wherein the light guide plate comprises a lateral surface opposite to the incident side, and an illuminating surface connecting the incident side and the lateral surface and a bottom surface opposite to the illuminating surface, and the reflective sheet stacks on the bottom surface, and the quantum dot thin film stacks on the illuminating surface, and the two extending sections are respectively bent toward the incident side and the lateral surface and adhered on a surface of the reflective sheet away from the bottom surface.

3. The backlight module according to claim 2, wherein double-side tapes are provided between the two extending sections and the reflective sheet.

4. The backlight module according to claim 2, wherein double-side tapes are provided at the two extending sections away from surfaces of the reflective sheet.

5. The backlight module according to claim 3, wherein a length of the extending section of the quantum dot thin film bent and adhered with the reflective sheet is smaller than a half of a length of the reflective sheet.

6. The backlight module according to claim 4, wherein a length of the extending section of the quantum dot thin film bent and adhered with the reflective sheet is smaller than a half of a length of the reflective sheet.

7. The backlight module according to claim 5, wherein the backlight module further comprises an optical film, and the optical film covers on the mainbody of the quantum dot thin film.

8. The backlight module according to claim 6, wherein the backlight module further comprises an optical film, and the optical film covers on the mainbody of the quantum dot thin film.

9. The backlight module according to claim 5, wherein an edge of the extending section of the quantum dot thin film in an extending direction is a cut edge as cutting the quantum dot thin film.

10. The backlight module according to claim 6, wherein an edge of the extending section of the quantum dot thin film in an extending direction is a cut edge as cutting the quantum dot thin film.

11. The backlight module according to claim 5, wherein the quantum dot thin film is formed with quantum dots of mixed various sizes which are packaged by PET material.

12. The backlight module according to claim 6, wherein the quantum dot thin film is formed with quantum dots of mixed various sizes which are packaged by PET material.

13. A display device, comprising a liquid crystal panel and a backlight module, and the backlight module comprises a glue frame, a light guide plate, a backlight source, a reflective sheet and a quantum dot thin film, and the light guide plate, the backlight source, the reflective sheet, the quantum dot thin film are located in the glue frame, and the backlight source is located at an incident side of the light guide plate, and the quantum dot thin film comprises a mainbody and extending sections at opposite two ends of the mainbody, and the reflective sheet and a mainbody layer of the quantum dot thin film stack at two opposite surfaces of the light guide plate, and the two opposite extending sections are respectively bent toward the incident side of the light guide plate and the other side opposite to the incident side and adhered on the reflective sheet, and the liquid crystal panel is located on the backlight module, and the liquid crystal panel covers the optical film.

14. The display device according to claim 13, wherein as double-side tapes are provided on surface of the two extending sections away from the reflective sheet, the double-side tapes are employed to fix the liquid crystal panel and the optical film.

15. The display device according to claim 13, wherein the light guide plate comprises a lateral surface opposite to the incident side, and an illuminating surface connecting the incident side and the lateral surface and a bottom surface opposite to the illuminating surface, and the reflective sheet stacks on the bottom surface, and the quantum dot thin film stacks on the illuminating surface, and the two extending sections are respectively bent toward the incident side and the lateral surface and adhered on a surface of the reflective sheet away from the bottom surface.

16. The display device according to claim 15, wherein double-side tapes are provided between the two extending sections and the reflective sheet.

17. The display device according to claim 15, wherein double-side tapes are provided at the two extending sections away from surfaces of the reflective sheet.

18. The display device according to claim 16, wherein a length of the extending section of the quantum dot thin film bent and adhered with the reflective sheet is smaller than a half of a length of the reflective sheet.

19. The display device according to claim 17, wherein a length of the extending section of the quantum dot thin film bent and adhered with the reflective sheet is smaller than a half of a length of the reflective sheet.

20. The display device according to claim 18, wherein the backlight module further comprises an optical film, and the optical film covers on the mainbody of the quantum dot thin film.
